(19) United States
(12) Patent Application Publication
(10) Pub. No.: US 2025/0303746 A1
(43) Pub. Date: Oct. 2, 2025

(54) PRINTING APPARATUS AND CONTROL METHOD THEREOF

(71) Applicant: Genix Corporation, Seongnam-si (KR)

(72) Inventors: Steve Park, Seongnam-si (KR); Il Kwon Kang, Yongin-si (KR)

(21) Appl. No.: 19/021,839

(22) Filed: Jan. 15, 2025

(30) Foreign Application Priority Data
Mar. 29, 2024 (KR) 10-2024-0043619

(51) Int. Cl. B41J 2/325; B41J 3/407; B41J 11/00; B41J 33/00; B41J 35/38; D06P 5/24

(52) U.S. Cl. CPC B41J 2/325; B41J 3/4078; B41J 11/0095; B41J 33/003; B41J 35/38; D06P 5/003

(57) ABSTRACT

A printing apparatus is proposed. The apparatus may include a housing, an application unit configured to apply a binder onto a print area of a print medium by using a thermal transfer method, wherein the print medium moves in a direction with respect to the housing, and a processor electrically connected to the application unit and configured to control an operation of the application unit. The application unit may include a binder ribbon including a binder, a first roll around which an end of the binder ribbon is wound, a second roll around which another end of the binder ribbon is wound, and a thermal transfer unit configured to thermally transfer the binder from the binder ribbon to the printing area.

### CROSS-REFERENCE TO RELATED APPLICATION

This application is based on and claims priority under 35 U.S.C. § 119 to Korean Patent Application No. 10-2024-0043619, filed on Mar. 29, 2024, in the Korean Intellectual Property Office, the disclosure of which is incorporated by reference herein in its entirety.

### BACKGROUND

### Technical Field

The disclosure relates to a printing apparatus and a control method thereof, and more particularly, to a printing apparatus configured to apply a binder onto a print area by using a thermal transfer method and a control method of the printing apparatus.

### Description of Related Technology

Images such as artworks, texts, and logos may be printed on fabrics and clothes by applying binders on surfaces of print media onto which images have been printed.

### SUMMARY

One aspect is a printing apparatus that includes a housing, an application unit configured to apply a binder onto a print area of a print medium by using a thermal transfer method, wherein the print medium is configured to move in a direction with respect to the housing, and a processor electrically connected to the application unit and configured to control an operation of the application unit, wherein the application unit includes a binder ribbon including the binder, a first roll around which an end of the binder ribbon is wound, a second roll around which another end of the binder ribbon is wound, and a thermal transfer unit configured to thermally transfer the binder from the binder ribbon onto the print area.

The binder may be thermally transferred onto the print area from the binder ribbon unwound from the first roll, and the binder ribbon, from which the binder has been peeled of, may be rewound around the second roll.

The binder ribbon may include a first surface and a second surface, wherein the first surface may include a binder and may be in contact with the print area due to the thermal transfer unit during thermal transfer, and the second surface may not include the binder and may be in contact with the thermal transfer unit while the thermal transfer.

The binder may include thermoplastic polyurethane (TPU).

The printing apparatus may further include a sensor located on a transfer path of the print medium and configured to generate a trigger signal in response to sensing a marker printed on the print media, and the processor may be configured to initiate an operation of the application in response to the generated trigger signal.

The marker may include at least one of a Quick Response (QR) code, a register mark, and an encoder marking.

The printing apparatus may further include a printing unit arranged on a transfer path of the print medium and configured to print images through digital methods on the print area of the print medium, and the processor may be electrically connected to the print unit and configured to further control the operation of the printing unit.

The application unit may be apart from the printing unit in a direction in which the print medium moves.

After the image is printed onto the print area by using the printing unit, the binder may be applied onto the print area by the application unit.

Another aspect is a control method of a printing apparatus that includes moving a print medium in the printing apparatus in a direction with respect to a housing of the printing apparatus, and applying a binder via a thermal transfer method onto a print area of the print medium by using an application unit of the printing apparatus, the application unit being located on a transfer path of the print medium, wherein the application unit includes a binder ribbon including the binder, a first roll around which an end of the binder ribbon is wound, a second roll around which another end of the binder ribbon is wound, and a thermal transfer unit configured to thermally transfer the binder from the binder ribbon onto the print area.

The applying of the binder via the thermal transfer method onto the print area of the print medium by using the thermal transfer method by the application unit may include initiating an operation of the application unit, controlling the binder ribbon to be unwound from the first roll and then wound around the second roll, thermally transferring the binder from the binder ribbon to the print area by the thermal transfer unit.

The initiating of the operation of the application unit may include generating a trigger signal, by a sensor, in response to the marker printed onto the print medium, and initiating the operation of the application unit in response to the trigger that has been generated.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a perspective view of a printing apparatus according to an embodiment;

FIG. 2 is a cross-sectional view for describing an internal configuration of the printing apparatus shown in FIG. 1.

FIG. 3 is a cross-sectional view illustrating an application unit in the printing apparatus shown in FIG. 1, for applying a binder onto a print area.

FIG. 4 is a cross-sectional view of a printing apparatus according to another embodiment;

FIG. 5 is a diagram illustrating a print area with no binder applied, the print area while the binder is being applied, and the print area with the binder applied.

FIG. 6 is a flowchart for describing a control method of a printing apparatus, according to an embodiment.

### DETAILED DESCRIPTION

Recently, there has been increasing interest in the printing industry about an apparatus and method of printing images onto print media through a digital method. Typical printing apparatuses configured to print images on print media through digital methods include inkjet printing apparatuses and laser beam printing apparatuses.

However, an analogue method such as spraying a powder-type binder and performing melting and drying processes has been continuously used as a method of applying a binder onto a print medium on which an image is printed. Therefore, there is gap between a method of printing an image onto a print medium and a method of applying a binder onto a print medium on which an image is printed.

Due to convenience of distribution and the like, binders mainly used in printing technology are generally treated in a powder phase. Binders in a powder phase may be sprayed onto a print area, melted and dried in an oven, and then applied onto the print area.

Binders in a powder phase may be inhaled by users of printing apparatuses. Particularly, as harmful gases are generated in a process of melting and drying the binders in a powder phase, the respiratory organs of the users of the printing apparatuses may be severely affected.

In addition, as the binders in a powder phase are sprayed onto print areas, the binders may be not uniformly applied onto the print area. When an excessive amount of binder is sprayed, additional processes to partially remove the sprayed binder may be further performed or a time period for drying the sprayed binder may increase. In addition, when an insufficient amount of binder is sprayed, adhesion of the binder in the print area output from the printing apparatus may be poor.

Therefore, the disclosure provides a printing apparatus configured to apply a binder onto a print medium by using a thermal transfer method and a control method of the printing apparatus.

Technical goals to be achieved through embodiments are not limited thereto, and other technical goals not mentioned herein may be clearly understood by one of ordinary skill in the art based on the present specification and the accompanying drawings.

Additional aspects will be set forth in part in the description which follows and, in part, will be apparent from the description, or may be learned by practice of the presented embodiments of the disclosure.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Regarding terms used in embodiments, general terms currently and wisely used are selected in consideration of functions in the disclosure. However, meanings of the terms may be changed according to intentions of one of ordinary skill in the art, judicial precedence, appearance of a new technology, and the like. In addition, in certain cases, terms may be arbitrarily selected by the applicant in particular cases. In such a case, the meaning of the terms will be described in detail at the corresponding portion in the description of the disclosure. Therefore, the terms used in the disclosure should be defined based on the meanings of the terms and the descriptions throughout the present disclosure.

The terms used in the embodiments are only used to describe particular embodiments, and are not used to limit the embodiments. In embodiments, unless explicitly indicates a singular expression, the singular expression may also encompass a plural expression.

In the disclosure, expression that a portion “includes” components or operations should not be interpreted as including all components or operations, but should be interpreted that the portion may not include some of the components or operations or further include additional components and operations.

In addition, in the disclosure, orders of operations describing the method according to embodiments are not limited orders of the operations described herein, and may be performed in appropriate orders considering the functions in the disclosure.

As used herein, an expression such as “at least only one” precedes arranged elements, it modifies all elements rather than each arranged elements. For example, the expression “at least any one of a, b, and c” should be construed to include a, b, c, or a and b, a and c, b and c, or a, b, and c.

In addition, when a component is “connected” to another component, this not only includes “being directly connected”, but also includes “being electrically connected” with another component therebetween.

The terms “-er”, “-or”, and “module” described in the present disclosure indicate units for processing at least one function and operation, and may be implemented by hardware components or software components and combinations thereof.

Hereinafter, the embodiments will be described in detail with reference to the accompanying drawings such that the embodiments may be easily practiced by one of ordinary skill in the art. However, the embodiments may be implemented in many different forms, and are not limited to the embodiments described herein.

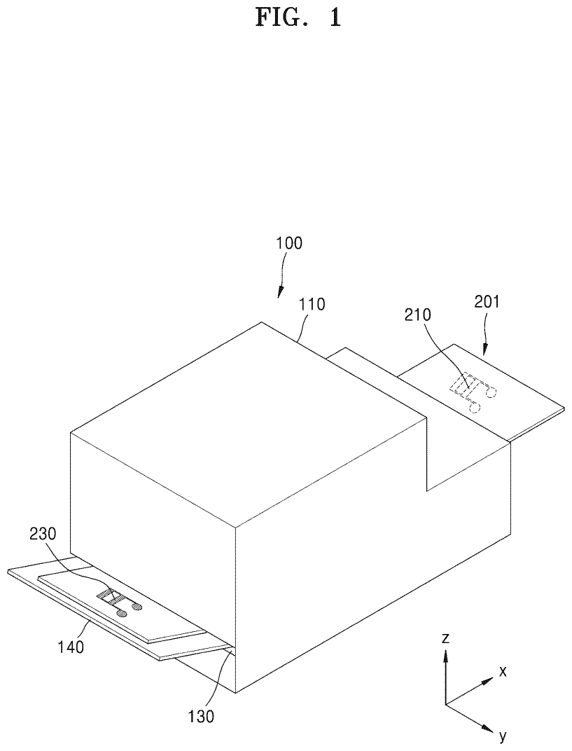

FIG. 1 is a perspective view of a printing apparatus 100 according to an embodiment. Referring to FIG. 1, the printing apparatus 100 according to an embodiment may include a housing 110, an inlet (not shown), an outlet 130, and a stacker 140.

The housing 110 may form an entire appearance of the printing apparatus 100, and components of the printing apparatus 100 may be accommodated in an internal space (or ‘a mounting space’) in the housing 110.

The inlet for inserting or inputting a print medium 201 into the internal space of the housing 110 may be formed in an area of the housing 110. The print medium 201 may be inserted into the internal space of the housing 110 through the inlet.

One or more driving units configured to move the print medium 201 in a direction (e.g., a-x axis direction) with respect to the housing 110 may be further arranged in the internal space of the housing 110. For example, the driving units may include a rail, a rack-and-pinion actuator, a driving roller, a gear, and a belt, and thus may move the print medium 201 in a direction.

The outlet 130 may be formed in another area of the housing 110 that is apart from the area of the housing 110 in which the inlet is formed. The area of the housing 110, in which the inlet is formed, and the other area of the housing 110, in which the outlet 130 is formed, may be arranged to face each other with respect to the housing 110.

The print medium 201, which is inserted into the internal space of the housing 110 through the inlet of the housing 110, may be moved in a direction with respect to the housing 110, and may be output or discharged to outside of the housing 110 through the outlet 130.

The print media 201 output to the outside of the housing 110 through the outlet 130 may be stacked on the stacker 140. The stacker 140 may be in an area adjacent to the outlet 130, and thus may support the print medium 201 output from the outlet 130. The print media 201 output from the outlet 130 may be stacked up on the stacker 140.

A print area may be set in at least one area of the print medium 201. The printing apparatus 100 may be configured to apply a binder on a print area of the print medium 201 inserted therein. For example, after the print medium 201 with the print area 210, onto which the binder has not been applied, is inserted into the printing apparatus 100, a print area 230, onto which the binder has been applied, may be output from the printing apparatus 100. In this case, the print area 210 where the binder has not been applied may be in a state in which an image has already been printed, and the print area 230 where the binder has been applied may be in a state in which the binder is further applied on the printed image.

In the related art, a method of applying a binder onto the print area by spraying the binder in a powder phase onto the print area and then melting and drying the sprayed binder by using an oven is mainly used.

In the related art, as the binder in a powder phase is sprayed onto the print area, users of the printing apparatus 100 may inhale the binder during a printing process. In addition, the method in the related art includes processes of melting and drying the binder sprayed onto the print area by using an oven, and in these processes, it is likely that harmful gases bad for health of the users.

In the related art, as the binder in a powder phase is sprayed onto the print areas, the binder may not be uniformly applied onto each print area. An excessively great amount of binder may be sprayed onto the print area, or alternatively, an insufficient amount of binder may be sprayed onto the print area.

For example, when an excessive amount of binder is sprayed onto the print area, a process of partially removing the binder that has been excessively sprayed may be additionally required.

For example, a process as follows may be additionally performed: partially blowing off the binder that has been excessively sprayed, by spraying air; or a process of partially shaking off the sprayed binder by applying vibration and/or impact to the print medium onto which the excessive amount of binder has been sprayed, by rotating a paddle.

As another example, when an excessive amount of binder is sprayed onto the print area, an additional component and/or process may be required to dry the binder that has been excessively sprayed. For example, it is required to increase the number of ovens to dry the excessive amount of binder, or a time period for drying the excessive amount of binder may further increase.

As another example, only an insufficient amount of binder may be sprayed onto the print area, and in this case, the binder of the print area that has been output may have poor adhesion.

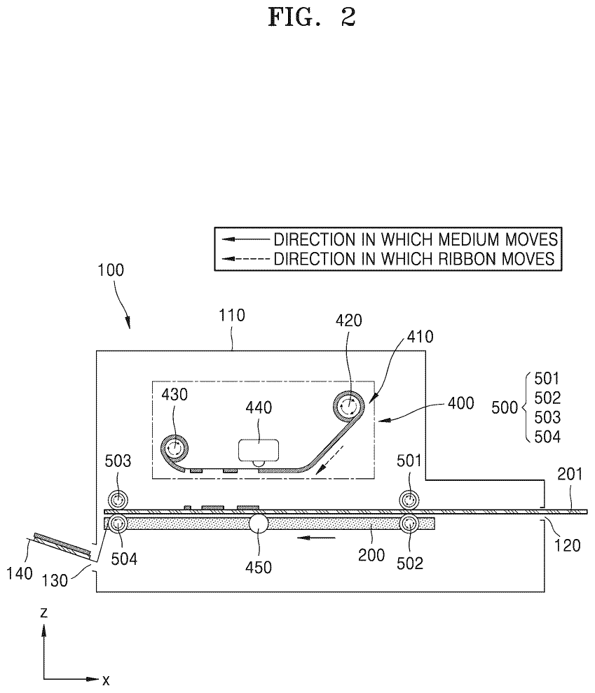

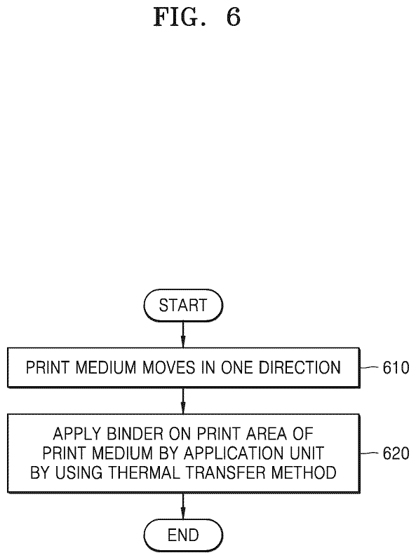

Hereinafter, the printing apparatus 100 and a method of controlling the printing apparatus 100 are provided to solve the aforementioned problems in the related art. Hereinafter, the printing apparatus 100, in which the thermal transfer method is used, will be described with reference to FIGS. 2 to 5, and the method of controlling the printing apparatus 100 in which the thermal transfer method is used will be described with reference to FIG. 6.

FIG. 2 is a cross-sectional view for describing an internal configuration of the printing apparatus 100 shown in FIG. 1. Referring to FIG. 2, the printing apparatus 100 may include the housing 110, an inlet 120, the outlet 130, the stacker 140, a coating unit 400, and a driving unit 500. The printing apparatus 100 shown in FIG. 2 may be an embodiment of the printing apparatus 100 shown in FIG. 1, and descriptions thereof will not be repeatedly given. Components related to the embodiments are shown in the printing apparatus 100 shown in FIG. 2, and it would be obvious to one of ordinary skill in the art that other components may be further included in the printing apparatus 100 in addition to the components shown in FIG. 2.

The inlet 120 may be formed in an area of the housing 110. The outlet 130 may be formed in another area of the housing 110, and the area and the other area may be arranged to face each other with respect to the housing 110. The print media 201 may be inserted into the housing 110 through the inlet 120, output to the outside of the housing 110 through the outlet 130, and stacked on the stacker 140.

One or more driving units 500 configured to move the print media 201 in a direction (e.g., the −x axis direction) with respect to the housing 110 may be accommodated in the internal space of the housing 110. For example, the driving units 500 may include a rail, a rack-and-pinion actuator, a driving roller, a gear, and a belt, and thus may move the print media 201 in a direction.

The driving unit 500 may be arranged at an upper end and/or a lower end of the print media 201 located upstream and/or downstream the print media 201 to move the print media 201 in a certain direction.

In the disclosure, the wording “upstream the printing apparatus 100” may indicate an area on the movement path of the print medium 201 located before the print medium 201 arrives at the application unit 400. For example, the upstream of the printing apparatus 100 may indicate an area located between the inlet 120 of the printing apparatus 100 and the application unit 400.

In addition, in the disclosure, the wording “downstream the printing apparatus 100” may indicate an area on the movement path of the print medium 201 located after the print medium 201 passes through the application unit 400. For example, the downstream of the printing apparatus 100 may indicate an area located between the application unit 400 and the outlet 130 of the printing apparatus 100.

For example, a first driving unit 501 and a second driving unit 502 may be at the upper end and the lower end upstream the printing apparatus 100, respectively, and a third driving unit 503 and a fourth driving unit 504 may be at the upper end and the lower end of the print medium 201 downstream the printing apparatus 100.

In addition, in an area of the movement path of the print medium 201, at which the print medium 201 arrives the application unit 400, a flat-roll 450 may be arranged at the lower end of the print media 201 as a driving unit of the print medium 201. The flat-roll 450 may facilitate moving and pause of the print medium 201 even while thermal transfer is performed on the print area of the print medium 201 by the thermal transfer unit 440.

The driving unit 500 may further include a flat-bed 200 for supporting and guiding the print media 201. Holes penetrating the flat-bed 200 may be formed in an area of the flat-bed 200, and the second driving unit 502, the fourth driving unit 504, and a flat role 450, which are arranged at the lower end of the print medium 201, may be accommodated in the holes that have been formed.

Although an embodiment in which only the print medium 201 is moved in a direction by the driving unit 500 and the flat-bed 200 does not move is illustrated in the drawing, the embodiment is not limited thereto. For example, the driving unit 500 may be arranged at the upper end and/or the lower end of the flat-bed 200 located upstream and/or downstream the printing apparatus 100 to move the flat-bed 200 and the print medium 201 in a direction.

The application unit 400 may be on the movement path of the print medium 201, and may apply the binder, by using the thermal transfer method, onto the print area of the print medium 201 that has arrived at the application unit 400.

Although not illustrated, the printing apparatus 100 according to an embodiment may further include a processor. The processor may be accommodated in the internal space of the housing 110 and may be configured to general operations of the application unit 400 and/or the driving unit 500.

The processor may be electrically connected to the application unit 400 and generally control operations performed by the application unit 400 to apply white ink in the print area of the print medium 201. The processor may control moving of the print medium 201 by controlling the operation of the driving unit 500, and accordingly, the binder may be applied at desired positions in the print medium 201.

In addition, although not illustrated, the printing apparatus 100 may further include a printing unit configured to print images on the print area. The printing unit may be arranged upstream of the printing apparatus 100. For example, the printing unit may be arranged in an area between the inlet 120 of the printing apparatus 100 and the application unit 400 in the movement path of the print medium 201. The printing unit may be configured to, by using a digital method, additionally print the image onto the print medium 201 inserted into the printing apparatus 100.

The application unit 400 may be arranged apart from the printing unit. For example, the application unit 400 may be arranged from the printing unit in a direction in which the print medium 201 moves (e.g., the −x axis direction). After an additional image is printed onto the print medium 201 by the printing unit, the binder 413 may be further applied by the application unit 400 onto a surface of the printed image.

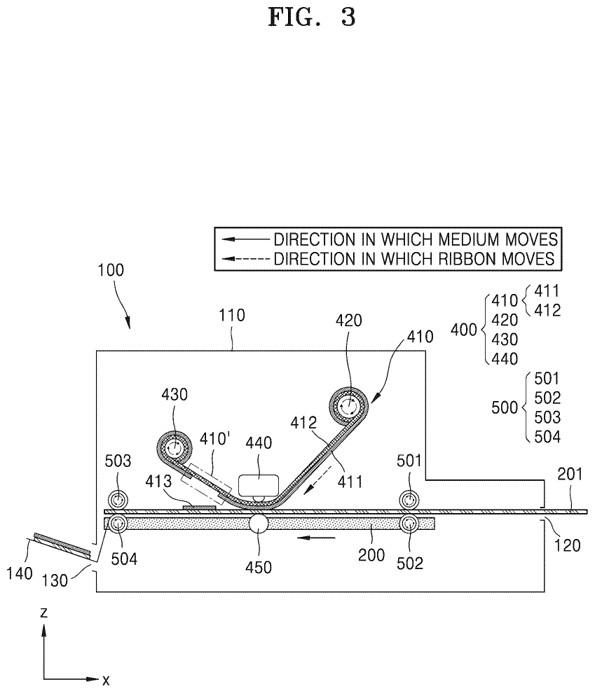

Hereinafter, the application unit 400 configured to apply the binder onto the print area by using the thermal transfer method will be described in detail with reference to FIG. 3.

FIG. 3 is a cross-sectional view of the application unit 400 in the printing apparatus 100 shown in FIG. 1 applying the binder onto the print area. Referring to FIG. 3, the printing apparatus 100 shown in FIG. 3 may include the housing 110, the inlet 120, the outlet 130, the stacker 140, the application unit 400, and the driving unit 500. Components of the printing apparatus 100 shown in FIG. 3 may be identical or similar to the components of the printing apparatus 100 shown in FIGS. 1 and 2, and descriptions thereof will not be repeatedly given. Referring to FIG. 3, the coating unit 400 may include a binder ribbon 410, a first roll 420, a second roll 430, and a thermal transfer unit 440.

The binder ribbon 410 may include a binder. The binder of the binder ribbon 410 may be applied onto the print area of the print media 201 by using a thermal transfer method.

An end of the binder ribbon 410 may be wound around the first roll 420, and another end of the binder ribbon 410 may be wound around the second roll 430. The binder ribbon 410 before the binder is applied onto the print area may be wound around the first roll 420, and the binder ribbon 410 after the binder has been applied onto the print area may be wound around the second roll 420.

To apply the binder 413 in the binding area, the thermal transfer unit 440 may push the binder ribbon 410 in a direction toward the print media 201 (e.g., a-z axis direction). In this process, a portion of the binder ribbon 410 may be unwound from the first roll 420. The binder ribbon 410 unwound from the first roll 420 may be in contact with the print area of the print media 201 by the thermal transfer unit 440.

The binder ribbon 410 may include a first surface 411 including the binder and a second surface 412 not including the binder. While the binder is being applied onto the print area, the first surface 411 may be in contact with the print area, and the second surface 412 may be in contact with the thermal transfer unit 440.

The thermal transfer unit 440 may be in contact with the second surface 412 of the binder ribbon 410 and may push the binder ribbon 410 in the direction (e.g., the −z axis direction) toward the print media 201. Accordingly, a portion of the binder ribbon 410 may be unwound from the first roll 420, and the first surface 411 of the binder ribbon 410 that is unwound may be in contact with the print area of the print media 201.

In a state where the first surface 411 of the binder ribbon 410 is in contact with at least an area of the print area, the thermal transfer unit 440 may apply heat and/or pressure on the binder ribbon 410. Due to the heat and/or the pressure applied from the thermal transfer unit 440, the binder 413 may be thermally transferred from the first surface 411 of the binder ribbon 410 to the print area. While thermal transfer is performed by the thermal transfer unit 440, the binder 413 may be peeled off from the first surface 411 of the binder ribbon 410, and the binder 413 peeled off from the first surface 411 may be applied onto the print area. Simultaneously or thereafter, a binding ribbon 410′ from which the binder is peeled off may be rewound around the second roll 430.

The binder 413 applied onto the print area by using the thermal transfer method may include thermoplastic polyurethane (TPU). Although a type of the binder 413 is not limited thereto, and any high molecular weight compound having the property of being applied onto the print area through the thermal transfer method and the property of being capable of giving appropriate adhesion to the high-molecular weight compound may be used without limitation as the binder 413.

The printing apparatus 100 according to the disclosure may apply the binder 413 onto the print area through the thermal transfer method by using the application unit 400. As it is not necessary handle the binder used via the thermal transfer method in a powder phase, the printing apparatus 100 according to the disclosure may be configured to protect users of the printing apparatus 100 from inhaling the binder in a powder phase.

In addition, the binder used for the printing apparatus 100 according to the disclosure does not have to be melted or dried, and accordingly, the printing apparatus 100 may protect the user from harmful gases generated in the process of melting and drying the binder.

Likewise, the printing apparatus 100 according to the disclosure may apply the binder 413 onto the print area even without additional components (e.g., an oven) configured to melt or dry the binder 413, and therefore, may be manufactured in small sizes, and may improve the easiness of manufacturing while reducing manufacturing cost.

The printing apparatus 100 may be easily adjusted such that the binder 413 having a uniform thickness may be applied onto the print area, and accordingly, the quality of print medium output from the printing apparatus 100 according to the disclosure may be improved.

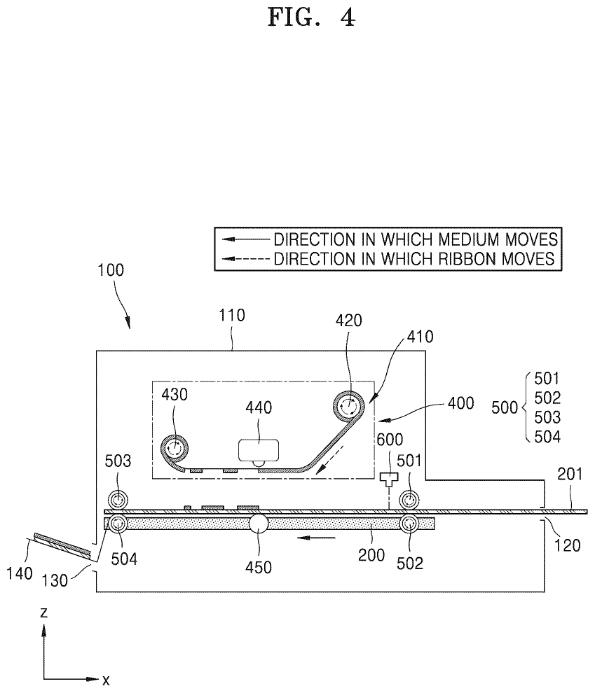

FIG. 4 is a cross-sectional view of the printing apparatus 100 according to another embodiment. Referring to FIG. 4, the printing apparatus 100 may include the housing 110, the inlet 120, the outlet 130, the stacker 140, the application unit 400, the driving unit 500, and a sensor 600. The printing apparatus 100 shown in FIG. 4 may be a printing apparatus 100 further including the sensor 600 in addition to the printing apparatus 100 shown in FIGS. 2 and 3, and descriptions thereof will not be repeatedly given.

The sensor 600 may be on a movement path of the print media 201. The sensor 600 may be upstream the printing apparatus 100. For example, the sensor 600 may be at an area right before arriving the application unit 400. The sensor 600 may be configured to generate a trigger signal to correspond to a marker printed on the print media.

To apply the binder 413 in a desired position of the print area through the thermal transfer method, a marker to indicate initiation of operations of the application unit 400 may be further printed on the print media. The sensor 600 may be configured to detect the marker printed on the print media. The sensor 600 may generate a trigger signal in response to the detected marker. When the trigger signal is generated by the sensor 600, a processor may control initiation of an operation of the application unit 400.

For example, the marker printed on the print media may include a Quick Response (QR) code or a register mark. That is, a two-dimensional barcode for delivering information regarding the initiation of the operation of the application unit 400 and a line that is a reference for the initiation of the operation of the application unit 400 may be printed onto an area of the print medium. In this case, the sensor 600 may include a trigger sensor configured to detect the QR code or the register mark. When the QR code or the register mark is detected, the sensor 600 may generate a trigger signal as a response thereto.

However, the embodiment is not limited thereto, and as another example, the marker printed on the print media may include an encoder marking. In this case, the sensor 600 may include a rotary encoder configured to detect the encoder marking. When the encoder marking is detected, the sensor 600 may generate a trigger signal in response thereto.

The printing apparatus 100 according to the disclosure may be configured to control the initiation of the operation of the application unit 400. Accordingly, the printing apparatus 100 may be configured to apply the binder 413 through the thermal transfer method in a desired position of the print area.

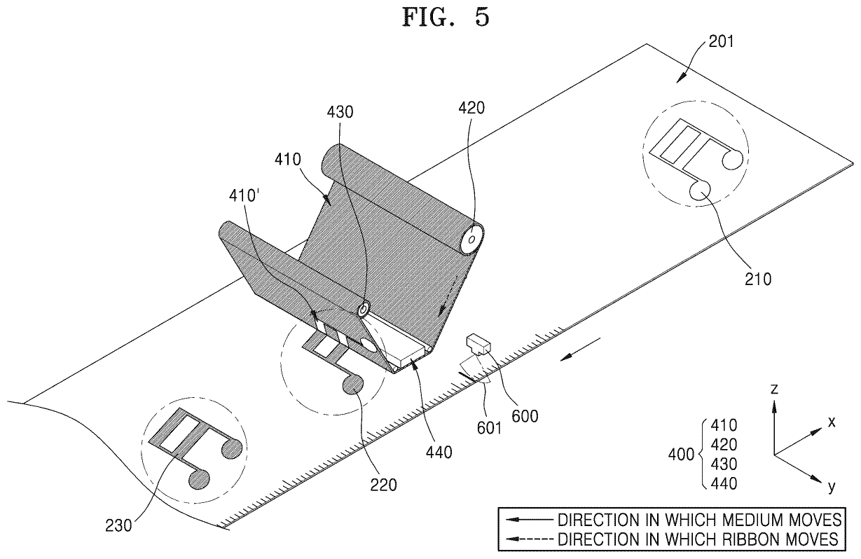

FIG. 5 is a diagram illustrating the print area onto which the binder 413 has not been applied, the print area onto which the binder 413 is being applied, and the print area onto which the binder 413 has been applied. For convenience of explanation, FIG. 5 only illustrates some of the components of the printing apparatus 100 shown in FIG. 4, but the components of the printing apparatus 100 are not limited to the configurations illustrated in the drawings. Accordingly, the descriptions given above regarding the printing apparatus 100 with reference to FIG. 4 may also be applied to the components of the printing apparatus 100 shown in FIG. 5.

The print area 210 onto which the binder 413 has not been applied may indicate the print area inserted into the printing apparatus 100. An image may have been already printed onto the print area 210 in which the binder 413 has not been applied.

The print media 201 with the print area 210 where the binder 413 has not been applied may be moved toward the application unit 400. The marker 601 indicating the initiation of the operation of the application unit 400 may be printed on the print media 201 with the print area 210 where the binder 413 has not been applied.

The sensor 600 may be configured to detect the marker 601 printed onto the print media 201 and generate a trigger signal in response to the marker 601 that has been detected. The processor may initiate the operation of the application unit 400 based on the generated trigger signal.

The print area 220 where the binder 413 is being applied may indicate a print area where the binder 413 is being thermally transferred onto the print area by the application unit 400. In the print area 220 where the binder 413 is being applied, the binder 413 may have been applied onto an area, and the binder 413 may have not been applied or may be being applied to another area.

The print area 230 where the binder 413 has been applied may indicate a state where the binder 413 has been completely applied by the application unit 400. The print area 230 after the application of the binder 413 may be moved toward the outlet 130 of the printing apparatus 100 and then may be output from the printing apparatus 100 through the outlet 130.

Hereinafter, the method of controlling the printing apparatus 100, which has been described above with reference to FIG. 4, will be described.

FIG. 6 is a flowchart for describing a control method of the printing apparatus 100, according to an embodiment. Referring to FIG. 6, the control method may include operations executed by the printing apparatus 100, which have been described above with reference to FIG. 4. Accordingly, the descriptions given above regarding the printing apparatus 100, which have been made with reference to FIG. 4, may also be applied to the method of controlling the printing apparatus 100 shown in FIG. 6.

The printing apparatus 100 may include the housing 110, the inlet 120, the outlet 130, the stacker 140, the application unit 400, and the driving unit 500.

The housing 110 may form an entire appearance of the printing apparatus 100, and the inlet 120 for inserting the print media 201 into the internal space of the housing 110 may be formed in an area of the housing 110.

A print area, onto which the binder 413 is applied, may be arranged in at least an area of the print media 201. Here, the print area may indicate a print area where an image has been printed in a digital method but the binder 413 has not been applied (e.g., the print area 210 shown in FIG. 5, onto which the binder 413 has not been applied).

The control method of the printing apparatus 100, according to an embodiment, may start when the print media 201 is inserted into the internal space of the housing 110.

In operation 610, the print media 201 inserted into the internal space of the housing 110 may be moved in a direction (e.g., the −x axis direction) with respect to the housing 110. The print media 201 may be inserted into the internal space of the housing 110 through the inlet 120. The inlet 120 may be arranged in an area of the housing 110. The outlet 130 may be arranged in another area of the housing 110 that is apart from the area of the housing 110. The area of the housing 110 and the other area of the housing 110 may be arranged to face each other with respect to the housing 110. The print media 201 may be inserted into the internal space of the housing 110 through the inlet 120 and moved in a direction toward the outlet 130 in the internal space of the housing 110.

One or more driving units configured to move the print medium 201 in a direction (e.g., a-x axis direction) with respect to the housing 110 may be further arranged in the internal space of the housing 110. For example, the driving units may include a rail, a rack-and-pinion actuator, a driving roller, a gear, and a belt, and thus may move the print medium 201 in a direction.

The driving unit 500 may be arranged at an upper end and/or a lower end of the print media 201 located upstream and/or downstream the print media 201 to move the print media 201 in a constant direction.

For example, the first driving unit 501 and the second driving u nit 502 may be at the upper end and the lower end upstream the printing apparatus 100, respectively, and the third driving unit 503 and a fourth driving unit may be at the upper end and the lower end of the print media 201 downstream the printing apparatus 100.

The driving unit 500 may further include a flat-bed 200 configured to support and guide the print media 201. Holes penetrating the flat-bed 200 may be formed in an area of the flat-bed 200, and the second driving unit 502, the fourth driving unit 504, and a flat role 450, which are arranged at the lower end of the print media 201, may be accommodated in the holes that have been formed.

In operation 620, the binder 413 may be applied onto the print area of the print media 201 by the application unit 400 through the thermal transfer method. The application unit 400 may be on the movement path of the print media 201, and may apply the binder 413 in the print area of the print media 201.

To apply the binder 413 onto the print area through the thermal transfer method, the printing apparatus 100 may be first controlled to initiate the operation of the application unit 400. A marker (e.g., the marker 601 in FIG. 5) indicating the initiation of the operation of the application unit 400 may be further printed on the print media 201. The printing apparatus 100 may include the sensor 600 configured to detect the marker 601 printed on the print media 201. When the marker 601 is detected by the sensor 600, the sensor 600 may generate a trigger signal in response to the marker 601 that has been detected, and the operation of the application unit 400 may be initiated based on the generated trigger signal.

The application unit 400 may include the binder ribbon 410, the first roll 420, the second roll 430, and the thermal transfer unit 440, and may apply the binder 413 onto the print area through the thermal transfer method.

The binder ribbon 410 may include: the binder 413; the first surface 411 being in contact with the print area by the thermal transfer unit 440 while the binder 413 is being applied onto the print area; and the second surface 412 that does not include the binder 413 and is in contact with the thermal transfer unit 440 while the binder 413 is being applied onto the print area.

An end of the binder ribbon 410 may be wound around the first roll 420, and another end of the binder ribbon 410 may be wound around the second roll 430. An end of the binder ribbon 410 may be unwound from the first roll 420 to apply the binder 413 in the print area.

The thermal transfer unit 440 may be in contact with the second surface 412 of the binder ribbon 410 and may push the binder ribbon 410 in the direction (e.g., the −z axis direction) toward the print media 201. Accordingly, a portion of the binder ribbon 410 may be unwound from the first roll 420, and the first surface 411 of the binder ribbon 410 may be in contact with the print area of the print media 201. In a state where the first surface 411 of the binder ribbon 410 is in contact with at least an area of the print area, the thermal transfer unit 440 may apply heat and/or pressure on the binder ribbon 410.

As the thermal transfer unit 440 applies heat and/or pressure to the binder ribbon 410, the binder 413 may be peeled off from the first surface 411 of the binder ribbon 410. The binder 413 peeled off from the first surface 411 may be applied onto the print area. Simultaneously or thereafter, a binding ribbon 410′ from which the binder 413 is peeled off may be rewound around the second roll 430.

The control method of the printing apparatus, according to the disclosure, may include applying the binder 413 onto the print area through the thermal transfer method by using the application unit 400. As it is not necessary to handle the binder used via the thermal transfer method in a powder phase, the users of the printing apparatus 100 may be protected, through the method according to the disclosure, from inhaling the binder in a powder phase.

In addition, the binder used in the method of controlling the printing apparatus according to the disclosure does not have to be melted or dried, and thus, the user may be protected from harmful gases generated in the process of melting and drying the binder.

Likewise, according to the method of controlling the printing apparatus according to the disclosure, the binder 413 may be applied onto the print area even without additional configurations to melt or dry the binder, and therefore, may be manufactured in small sizes, and may improve the easiness of manufacturing while reducing the manufacturing cost.

According to the control method of the printing apparatus according to the disclosure, the binder 413 having a uniform thickness may be easily adjusted to be applied onto the print area, and accordingly, the quality of print medium output from the printing apparatus 100 may be improved.

The method according to the embodiments may also be implemented in the form of a recording medium including computer-executable instructions, e.g., a program module executed by a computer. A computer-readable medium may include any available media that may be accessed by a computer and includes all of volatile media, nonvolatile media, removable media, and non-removable media. In addition, the computer-readable medium may include a computer storage medium and a communication medium. The computer storage medium includes both volatile and nonvolatile, and removable and non-removable media implemented in any method or technology for storage of information such as computer readable instructions, data structures, program modules or other data. Communication medium may include computer readable instructions, data structures, other data in non-transitory data signals, such as program modules.

Those of ordinary skill in the art related to this embodiment understand that it may be implemented in a modified form without departing from the scope of the disclosure. Therefore, the embodiments of the disclosure should be considered as illustrative examples only, and should not be construed as limiting the scope of the disclosure. The scope of the disclosure is described in the claims rather than the foregoing description, and any modifications, substitutions and improvements of the embodiments of the disclosure should be construed as being included in the present disclosure.

According the printing apparatus and the method of controlling the same, according to the various embodiments, by applying the binder onto the print medium by using the thermal transfer method, the users of the printing apparatus may be protected from the binder in a powder phase and harmful gases.

In addition, according to the printing apparatus and the method of controlling the same, according to the various embodiments, the easiness of manufacturing the printing apparatus to apply the binder onto the print medium may be improved while reducing the manufacturing cost of the printing apparatus. Accordingly, the production efficiency of the printing apparatus for applying the binder onto the print medium may also be improved.

In addition, according to the printing apparatus and the method of controlling the printing device, according to various embodiments, the quality of printing may be improved by more uniformly applying the binder onto the print medium.

Advantageous effects obtained by the embodiments are not limited to the aforementioned embodiments, and other unmentioned effects may be clearly understood to one of ordinary skill in the art based on the present specification and the accompanying drawings.

What is claimed is:

1. A printing apparatus comprising:
a housing;
an application unit configured to apply a binder onto a print area of a print medium by using a thermal transfer method, wherein the print medium is configured to move in a direction with respect to the housing; and
a processor electrically connected to the application unit and configured to control an operation of the application unit,
wherein the application unit comprises:
a binder ribbon comprising the binder;
a first roll around which an end of the binder ribbon is wound;
a second roll around which another end of the binder ribbon is wound; and
a thermal transfer unit configured to thermally transfer the binder from the binder ribbon onto the print area.

2. The printing apparatus of claim 1, wherein:
the binder is configured to be thermally transferred onto the print area from the binder ribbon unwound from the first roll, and the binder ribbon, from which the binder has been peeled off, is rewound around the second roll.

3. The printing apparatus of claim 1, wherein the binder ribbon comprises:
a first surface comprising the binder and being in contact with the print area by the thermal transfer unit during thermal transfer; and
a second surface not comprising the binder and being in contact with the thermal transfer unit during thermal transfer.

4. The printing apparatus of claim 1, wherein the binder comprises thermoplastic polyurethane (TPU).

5. The printing apparatus of claim 1, further comprising:
a sensor located on a movement path of the print medium and configured to generate a trigger signal in response to sensing a marker printed on the print media,
wherein the processor is further configured to initiate the operation of the application unit in response to the generated trigger signal.

6. The printing apparatus of claim 5, wherein the marker comprises at least one of a Quick Response (QR) code, a register mark, or an encoder marking.

7. The printing apparatus of claim 1, further comprising:
a printing unit arranged on a movement path of the print medium and configured to print an image through a digital method on the print area of the print medium,
wherein the processor is electrically connected to the print unit and further configured to control an operation of the printing unit.

8. The printing apparatus of claim 7, wherein the application unit is apart from the printing unit in a direction in which the print medium moves.

9. The printing apparatus of claim 7, wherein, after the image is printed onto the print area by the printing unit, the binder is configured to be applied onto the print area by the application unit.

10. A control method of a printing apparatus, the control method comprising:
moving a print medium in a direction with respect to a housing of the printing apparatus; and
applying a binder via a thermal transfer method onto a print area of the print medium by using an application unit of the printing apparatus, the application unit being located on a movement path of the print medium,
wherein the application unit comprises:
a binder ribbon comprising the binder,
a first roll around which an end of the binder ribbon is wound,
a second roll around which another end of the binder ribbon is wound, and
a thermal transfer unit configured to thermally transfer the binder from the binder ribbon onto the print area.

11. The control method of claim 10, wherein:
applying of the binder via the thermal transfer method onto the print area of the print medium by using the application unit of the printing apparatus comprises:
initiating an operation of the application unit;
controlling the binder ribbon to be unwound from the first roll and then wound around the second roll; and
thermally transferring the binder from the binder ribbon to the print area by using the thermal transfer unit.

12. The control method of claim 11, wherein the initiating of the operation of the application unit comprises:
generating, by a sensor, a trigger signal in response to a marker printed onto the print medium; and
initiating the operation of the application unit in response to the generated trigger signal.
